(19) United States
(12) Patent Application Publication
(10) Pub. No.: US 2015/0015831 A1
(43) Pub. Date: Jan. 15, 2015

(54) LIQUID CRYSTAL DISPLAY PANEL AND DEVICE

(71) Applicant: HON HAI PRECISION INDUSTRY CO., LTD., New Taipei (TW)

(72) Inventor: JIAN-SHIHN TSANG, Tu-Cheng (TW)

(21) Appl. No.: 14/327,976

(22) Filed: Jul. 10, 2014

(30) Foreign Application Priority Data
Jul. 10, 2013 (TW) 102124766

(51) Int. Cl. G06F 1/18; G02F 1/1333

(52) U.S. Cl. CPC G06F 1/182; G02F 1/1333
USPC 349/96; 349/122

(57) ABSTRACT

A liquid crystal display panel which is protected from external static electricity includes a first substrate, a second substrate, a liquid crystal layer, and a graphene film. The second substrate is opposite to the first substrate. The liquid crystal layer is sandwiched between the first substrate and the second substrate. The graphene film is disposed at a side of the first substrate away from the liquid crystal layer.

### FIELD

The disclosure generally relates to display technologies.

### BACKGROUND

A liquid crystal display panel usually includes two substrates and a liquid crystal layer sandwiched between the two substrates. The liquid crystal display panel displays images by rotating liquid crystal molecules of the liquid crystal layer. A rotation of the liquid crystal molecules may be affected by external static electricity.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is an isometric diagram of a first embodiment of a liquid crystal display device.

FIG. 2 is a cross-sectional view of the liquid crystal display device taken along line V-V of FIG. 1.

FIG. 3 is a isometric diagram of a second embodiment of a liquid crystal display device.

FIG. 4 is a cross-sectional view of the liquid crystal display device taken along line V-V of FIG. 3.

FIG. 5 is a isometric diagram of a third embodiment of a liquid crystal display device.

FIG. 6 is a cross-sectional view of the liquid crystal display device taken along line V-V of FIG. 5.

FIG. 7 is a isometric diagram of a fourth embodiment of a liquid crystal display device.

FIG. 8 is a cross-sectional view of the liquid crystal display device taken along line V-V of FIG. 7.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

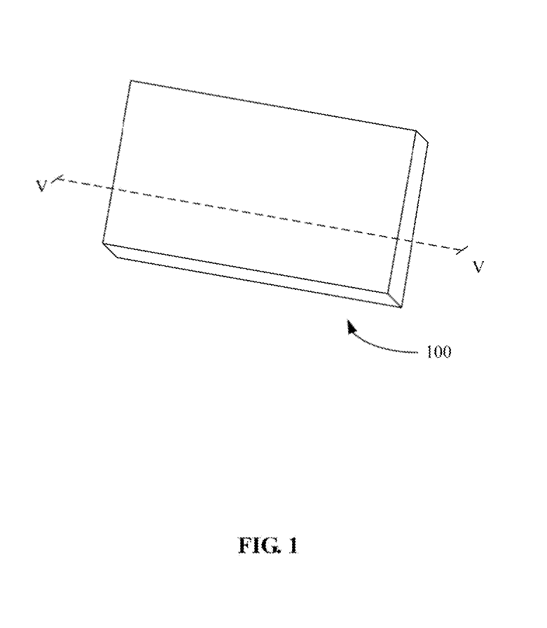

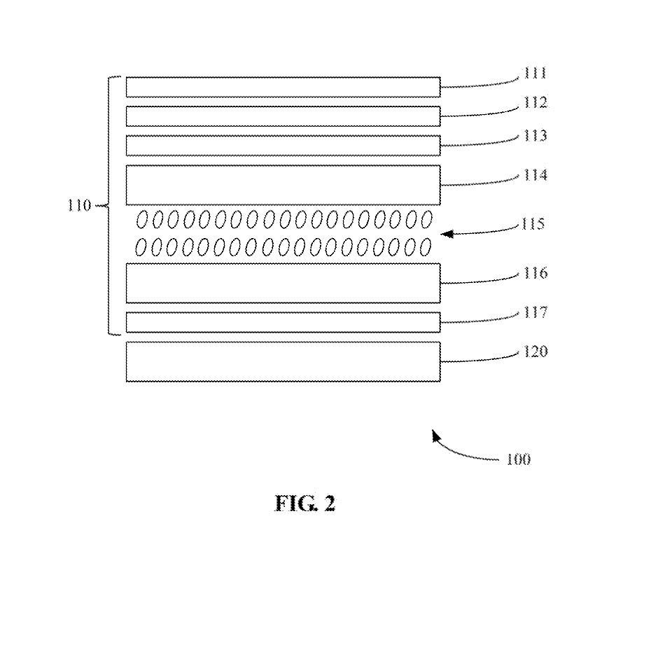

FIG. 1 illustrates a first embodiment of liquid crystal display device. FIG. 2 illustrates a cross-sectional view of the liquid crystal display device 100 taken along line V-V of FIG. 1. Referring to FIGS. 1 and 2, the liquid crystal display device 100 includes a liquid crystal display panel 110 and a backlight module 120. The liquid crystal display panel 110 includes a protective layer 111, a transparent conductive layer 112, a first polarizer 113, a first substrate 114, a liquid crystal layer 115, a second substrate 116, and a second polarizer 117.

The first substrate 114 is opposite to the second substrate 116. The liquid crystal layer 115 is sandwiched between the first substrate 114 and the second substrate 116. In at least one embodiment, the first substrate 114 is a color filter substrate, and the second substrate 116 is a thin film transistor array substrate.

The first polarizer 113 is disposed at a side of the first substrate 114 away from the liquid crystal layer 115. The second polarizer 117 is disposed at a side of the second substrate 116 away from the liquid crystal layer 115. The first polarizer 113 allows light to pass through in a first direction, and the second polarizer 117 allows light to pass through in a second direction which is perpendicular to the first direction.

The backlight module 120 is disposed at a side of the liquid crystal display panel 110 behind the second polarizer 117. The backlight module 120 provides backlighting for the liquid crystal display panel 110. The light from the backlight module 120 passes through the second polarizer 117, the second substrate 116, the liquid crystal layer 115, the first substrate 114, and the first polarizer 113 to display images.

In at least one embodiment, the transparent conductive layer 112 is disposed at a side of the first polarizer 113 away from the first substrate 114. The protective layer 111 is disposed at a side of the transparent conductive layer 112 away from the first polarizer 113. The transparent conductive layer 112 acts as a shield against external electrostatic charges. The protective layer 111 is made of polymethyl methacrylate (PMMA). The protective layer 111 protects the liquid crystal display panel 110 from damage.

In at least one embodiment, the transparent conductive layer 112 is a graphene film. An electrical conductivity of the transparent conductive layer 112 can be greater than 200 Siemens/cm (S/cm) and can be less than 2000 Siemens/cm (S/cm). The light absorption rate of the graphene film is about 2%, and the light transmittance of the transparent conductive layer 112 is more than 70%.

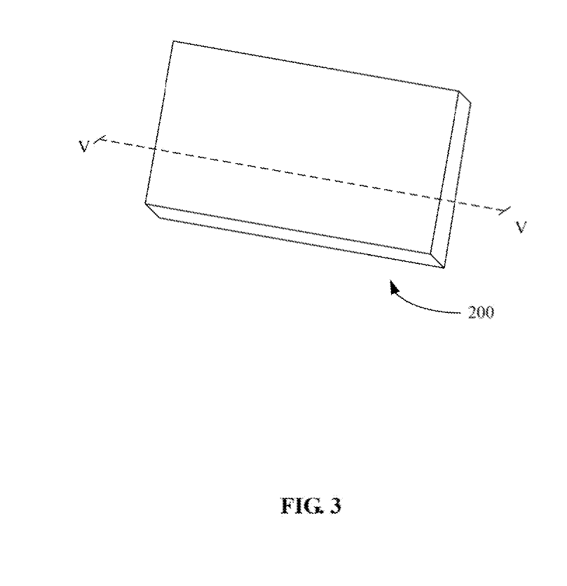

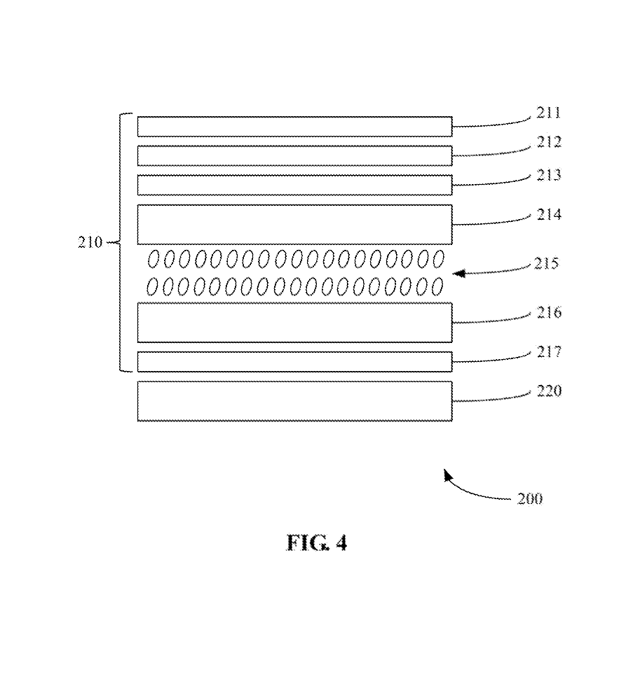

FIG. 3 illustrates a second embodiment of liquid crystal display device. FIG. 4 shows a cross-sectional view of the liquid crystal display device taken along line V-V of FIG. 3. Referring to FIGS. 3 and 4, the liquid crystal display device 200 includes a liquid crystal display panel 210 and a backlight module 220. The liquid crystal display panel 210 includes a protective layer 211, a first polarizer 212, a transparent conductive layer 213, a first substrate 214, a liquid crystal layer 215, a second substrate 216, and a second polarizer 217.

The first substrate 214 is opposite to the second substrate 216. The liquid crystal layer 215 is sandwiched between the first substrate 214 and the second substrate 216. In at least one embodiment, the first substrate 214 is a color filter substrate, and the second substrate 216 is a thin film transistor array substrate.

The first polarizer 212 is disposed at a side of the first substrate 214 away from the liquid crystal layer 215. The second polarizer 217 is disposed at a side of the second substrate 216 away from the liquid crystal layer 215. The first polarizer 212 allows light to pass through in a first direction, and the second polarizer 217 allows light to pass through in a second direction which is perpendicular to the first direction.

The backlight module 220 is disposed at a side of the liquid crystal display panel 210 behind the second polarizer 217. The backlight module 220 provides backlighting for the liquid crystal display panel 210. The light from the backlight module 220 passes through the second polarizer 217, the second substrate 216, the liquid crystal layer 215, the first substrate 214, and the first polarizer 212 to display images.

In at least one embodiment, the transparent conductive layer 213 is sandwiched between the first polarizer 212 and the first substrate 214. The protective layer 211 is disposed at a side of the first polarizer 212 away from the transparent conductive layer 213. The transparent conductive layer 213 shields against external electrostatic charges. The transparent conductive layer 213 is a graphene film, so that the liquid crystal display panel 210 is protected from static electricity.

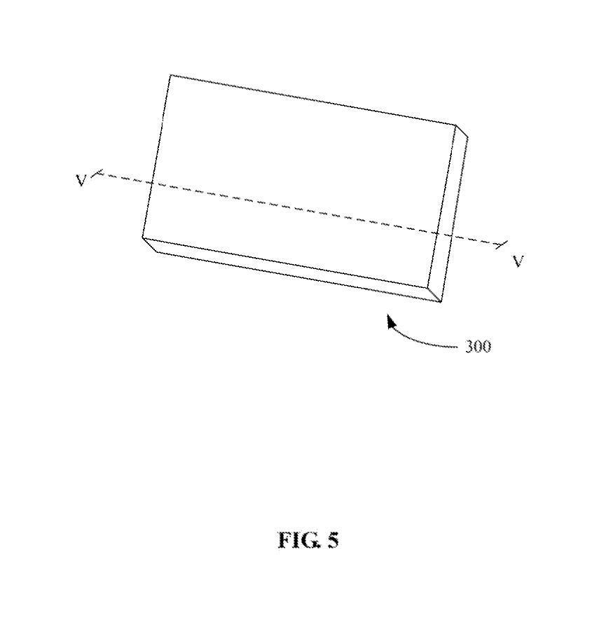

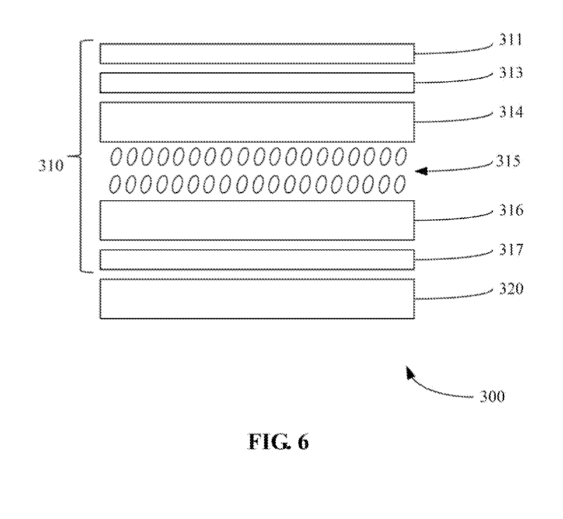

FIG. 5 illustrates a third embodiment of liquid crystal display device. FIG. 6 illustrates a cross-sectional view of the liquid crystal display device taken along line V-V of FIG. 5. Referring to FIGS. 5 and 6, the liquid crystal display device 300 includes a liquid crystal display panel 310 and a backlight module 320. The liquid crystal display panel 310 includes a conductive protective layer 311, a first polarizer 312, a first substrate 314, a liquid crystal layer 315, a second substrate 316, and a second polarizer 317.

The first substrate 314 is opposite to the second substrate 316. The liquid crystal layer 315 is sandwiched between the first substrate 314 and the second substrate 316. In at least one embodiment, the first substrate 314 is a color filter substrate, and the second substrate 316 is a thin film transistor array substrate.

The first polarizer 312 is disposed at a side of the first substrate 314 away from the liquid crystal layer 315. The second polarizer 317 is disposed at a side of the second substrate 316 away from the liquid crystal layer 315. The first polarizer 312 allows light to pass through in a first direction, and the second polarizer 317 allows light to pass through in a second direction which is perpendicular to the first direction.

The backlight module 320 is disposed at a side of the liquid crystal display panel 310 behind the second polarizer 317. The backlight module 320 provides backlighting for the liquid crystal display panel 310. The light from the backlight module 320 passes through the second polarizer 317, the second substrate 316, the liquid crystal layer 315, the first substrate 314, and the first polarizer 312 to display images.

The conductive protective layer 311 is disposed at a side of the first polarizer 312 away from the first substrate 314. In this embodiment, the conductive protective layer 311 is made of polymethyl methacrylate doping with graphene. The conductive protective layer 311 protects the liquid crystal display panel 310 from damage and shields against external electrostatic charges.

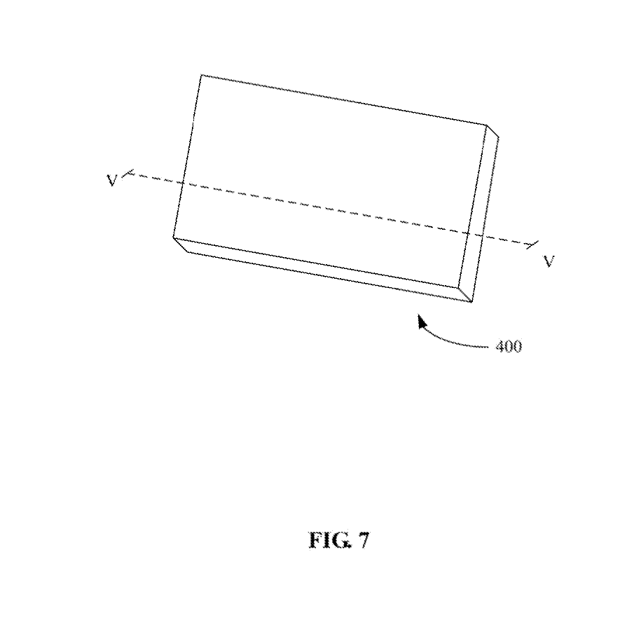

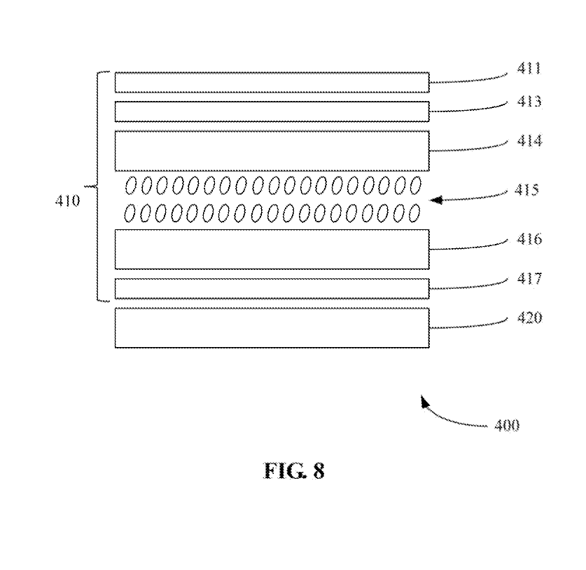

FIG. 7 illustrates a fourth embodiment of liquid crystal display device. FIG. 8 illustrates a cross-sectional view of the liquid crystal display device taken along line V-V of FIG. 7. Referring to FIGS. 7 and 8, the liquid crystal display device 400 includes a liquid crystal display panel 410 and a backlight module 420. The liquid crystal display panel 410 includes a protective layer 411, a conductive polarizer 413, a first substrate 414, a liquid crystal layer 415, a second substrate 416, and a second polarizer 417.

The first substrate 414 is opposite to the second substrate 416. The liquid crystal layer 415 is sandwiched between the first substrate 414 and the second substrate 416. In at least one embodiment, the first substrate 414 is a color filter substrate, and the second substrate 416 is a thin film transistor array substrate.

The conductive polarizer 413 is disposed at a side of the first substrate 414 away from the liquid crystal layer 415. The second polarizer 417 is disposed at a side of the second substrate 416 away from the liquid crystal layer 415. The conductive polarizer 413 allows light to pass through in a first direction, and the second polarizer 417 allows light to pass through in a second direction which is perpendicular to the first direction.

The backlight module 420 is disposed at a side of the liquid crystal display panel 410 behind the second polarizer 417. The backlight module 420 provides backlighting for liquid crystal display panel 410. The light from the backlight module 420 passes through the second polarizer 417, the second substrate 416, the liquid crystal layer 415, the first substrate 414, and the conductive polarizer 413 to display images.

The protective layer 411 is disposed at a side of the conductive polarizer 413 away from the first substrate 414 to protect the liquid crystal display panel 410 from damage. The protective layer 411 is made of PMMA. In at least one embodiment, the conductive polarizer 413 is a polarizer doping with graphene. The conductive polarizer 413 protects the liquid crystal display panel 410 against the effects of external static electricity.

It is believed that the discussed embodiments and their advantages will be understood from the foregoing description, and it will be apparent that various changes may be made thereto without departing from the disclosure or sacrificing all of its material advantages. The embodiments discussed herein do not limit the following claims.

What is claimed is:

1. A liquid crystal display panel comprising:
a first substrate having at a side;
a second substrate having a side that faces the side of the first substrate;
a liquid crystal layer sandwiched between the side of the first substrate and the side of the second substrate; and
a graphene film disposed at an outer side of the first substrate opposite the side sandwiching the liquid crystal layer for electrostatic shielding.

2. The liquid crystal display panel of claim 1 further comprising:
a protective layer disposed at a side of the graphene film opposite from the first substrate for protecting the liquid crystal display panel from damage;
a first polarizer disposed between the first substrate and the graphene film; and
a second polarizer disposed at a side of the second substrate opposite from the liquid crystal layer.

3. The liquid crystal display panel of claim 2, wherein the protective layer is made of polymethyl methacrylate.

4. The liquid crystal display panel of claim 2, wherein the light transmittance of the graphene film is more than 70%.

5. The liquid crystal display panel of claim 1 further comprising:
a protective layer disposed at a side of the graphene film opposite from the first substrate for protecting the liquid crystal display panel from damage;
a first polarizer disposed between the graphene film and the protective layer; and
a second polarizer disposed at a side of the second substrate opposite from the liquid crystal layer.

6. The liquid crystal display panel of claim 5, wherein the protective layer is made of polymethyl methacrylate.

7. The liquid crystal display panel of claim 5, wherein the light transmittance of the graphene film is more than 70%.

8. The liquid crystal display panel of claim 1, wherein the graphene film is a conductive protective layer, the conductive protective layer is disposed at a side of the first substrate away from the liquid crystal layer for protecting the liquid crystal display panel from damage and shielding external static electrostatic, the liquid crystal display panel further comprising:
a first polarizer disposed between the first substrate and the conductive protective layer; and
a second polarizer disposed at a side of the second substrate away from the liquid crystal layer.

9. The liquid crystal display panel of claim 8, wherein the conductive protective layer is made of polymethyl methacrylate doping with graphene.

10. The liquid crystal display panel of claim 1, wherein the graphene film is a conductive polarizer, the conductive polarizer is disposed at a side of the first substrate away from the liquid crystal layer for polarizing light and shielding external static electrostatic, the liquid crystal display panel further comprising:
a protective layer disposed at a side of the conductive polarizer away from the first substrate; and
a second polarizer disposed at a side of the second substrate away from the liquid crystal layer.

11. The liquid crystal display panel of claim 10, wherein the conductive polarizer is a polarizer doping with graphene.

12. A liquid crystal display device comprising:
a liquid crystal display panel and a backlight module, the backlight module provides a backlight to the liquid crystal display panel, the liquid crystal display panel comprises a first substrate having at a side, a second substrate having a side that faces the side of the first substrate, a liquid crystal layer sandwiched between the side of the first substrate and the side of the second substrate, and a graphene film disposed at an outer side of the first substrate opposite the side sandwiching the liquid crystal layer for electrostatic shielding.

13. The liquid crystal display device of claim 12 further comprising:
a protective layer disposed at a side of the graphene film opposite from the first substrate for protecting the liquid crystal display panel from damage;
a first polarizer disposed between the first substrate and the graphene film; and
a second polarizer disposed at a side of the second substrate opposite from the liquid crystal layer.

14. The liquid crystal display device of claim 13, wherein the protective layer is made of polymethyl methacrylate.

15. The liquid crystal display device of claim 13, wherein the light transmittance of the graphene film is more than 70%.

16. The liquid crystal display device of claim 12 further comprising:
a protective layer disposed at a side of the graphene film opposite from the first substrate for protecting the liquid crystal display panel from damage;
a first polarizer disposed between the graphene film and the protective layer; and
a second polarizer disposed at a side of the second substrate opposite from the liquid crystal layer.

17. The liquid crystal display device of claim 16, wherein the protective layer is made of polymethyl methacrylate.

18. The liquid crystal display device of claim 16, wherein the light transmittance of the graphene film is more than 70%.

19. The liquid crystal display device of claim 12, wherein the graphene film is a conductive protective layer, the conductive protective layer is disposed at a side of the first substrate away from the liquid crystal layer for protecting the liquid crystal display panel from damage and shielding external static electrostatic, the liquid crystal display panel further comprising:
a first polarizer disposed between the first substrate and the conductive protective layer; and
a second polarizer disposed at a side of the second substrate away from the liquid crystal layer.

20. The liquid crystal display panel of claim 12, wherein the graphene film is a conductive polarizer, the conductive polarizer is disposed at a side of the first substrate away from the liquid crystal layer for polarizing light and shielding external static electrostatic, the liquid crystal display panel further comprising:
a protective layer disposed at a side of the conductive polarizer away from the first substrate; and
a second polarizer disposed at a side of the second substrate away from the liquid crystal layer.
